(19) United States
(12) Patent Application Publication
(10) Pub. No.: US 2014/0278716 A1
(43) Pub. Date: Sep. 18, 2014

(54) MANAGEMENT AND SHARING OF SEGMENTS FROM WORKFLOWS AND BUSINESS PROCESSES

(71) Applicants: Mark William NIX, Cape San Blas, FL (US); Todd BUELOW, Charlotte, NC (US); Travis Christopher PARSONS, Charlotte, NC (US)

(72) Inventors: Mark William NIX, Cape San Blas, FL (US); Todd BUELOW, Charlotte, NC (US); Travis Christopher PARSONS, Charlotte, NC (US)

(21) Appl. No.: 13/836,042

(22) Filed: Mar. 15, 2013

(51) Int. Cl. G06Q 10/06

(52) U.S. Cl. CPC G06Q 10/06316
USPC 705/7.26

(57) ABSTRACT

Systems and method for sharing workflows are provided. In the various embodiments, trading partners make connections at an entity level associated with transaction flows. In particular, trading partners can share one or more segments of their respect workflows to allow another trading partner to share in visibility and management of a transaction through these states. In some embodiments, these workflows can be shared in a hub/spoke or hierarchical relationship, where a hub or parent entity can adjust and propagate changes in shared portions of a workflow as needed. In other embodiments, the workflows can be shared in a peer-to-peer basis, where different peers can gain access, as needed or allowed, to portions of another peer's workflow.

### FIELD OF THE INVENTION

The present technology relates to workflows and business processes and more specifically to apparatus and methods for managing and sharing segments from workflows and business processes.

### BACKGROUND

Computer applications, websites or other electronic content that include transaction management capabilities generally require a user to process a transaction by following established workflow steps. “Transactions” traditionally encompass shipments, orders, invoices, claims, appointments and various other agreements between parties. Thus, a transaction management represents the activity of coordinating, executing and monitoring these agreements between parties and their associated business processes.

Transaction management is typically represented using a “workflow”, which generally describes the flow of a transaction through the user experience. For example, a user may submit data into a form on a “New” transaction, and upon submittal, this transaction becomes a “Reviewed” transaction. The progression of the transaction from the “New” state to the “Reviewed” state, as a result of entering data into a specific form, represents the workflow for this example transaction.

Workflows for transaction management will typically range from very simple to very complex representations of business processes. These workflows can involve one or more entities, where each entity can be a user or an organization. Further such workflows can include collaboration whereby multiple entities participate collectively in the workflow.

A transaction workflow may also include participating entities that are associated with different business entities. For example, an order collaboration workflow may include a business process that shares information between a supplier entity and a customer entity. Similarly, a shipment collaboration workflow may include a business process that shares information between a shipper entity and a carrier entity.

In general, conventional websites (or any other shared system or application) for transaction management purposes are designed to help users view transaction information, process transaction workflow, and collaborate between multiple users by sharing information and visibility to transactions. Such websites for managing transactions may be used in various models of deployments to users. For example, these websites can be used by a single entity (company) to manage internal transactions. In another example, such websites can be used by multiple entities to collaborate (“business-to-business”). In still another example, these websites can be used by a company to allow consumers to interact with their entity (“business-to-consumer”).

Vendors of these websites typically deploy the application in multiple models. For example, vendors can deploy a website for a single entity. In this case, the website is enabled by application code running on a server and a database and the website is dedicated to one customer.

Alternatively, vendors of these websites can also deploy a “multi-tenant” model of their application, which allows multiple unique entities to run on a single version of application code running on a server and a database. This multi-tenant software architecture model is commonplace in software-as-a-service website offerings because it allows the vendor to offer the same product to multiple business entities (customers) without having to administer multiple versions of the same application.

In general, since multi-tenant applications utilize a common codebase and system architecture across customers, the software must typically be designed such that it “works” for all customers together. Further, to enable a one-size-fits-all software design across multiple customers, multi-tenant applications typically include customer settings that allow a customer to configure certain features of the offering to their needs. Unfortunately, since such multi-tenant applications are based on a one-size-fits-all approach, the amount of customization provided via such settings is typically limited. Thus, different customers are effectively limited to a same feature set and locked into a limited number of interaction methods. As a result, many customers are unable to deploy applications that include the level of customization they desire.

### SUMMARY

Systems and method for sharing workflows are provided. In the various embodiments, trading partners make connections at an entity level associated with transaction flows. In particular, trading partners can share one or more segments of their respective workflows to allow another trading partner to share in visibility and management of a transaction through these states. In some embodiments, these workflows can be shared in a hub/spoke or hierarchical relationship, where a hub or parent entity can adjust and propagate changes in shared portions of a workflow as needed. In other embodiments, the workflows can be shared in a peer-to-peer basis, where different peers can gain access, as needed or allowed, to portions of another peer's workflow.

### BRIEF DESCRIPTION OF THE DRAWINGS

FIG. 1 is a schematic of a multi-tenant workflow environment for a transaction network in accordance with the one exemplary embodiment of the present technology;

FIG. 2 is a schematic illustration of the operation of a workflow editor with respect to an application instance, in accordance with an embodiment of the present technology;

FIG. 3 is a flowchart of steps in an exemplary method for managing and sharing workflow in accordance with one embodiment of the present technology, with respect to requestor.

FIG. 4 is a flowchart of steps in an exemplary method for managing and sharing workflow in accordance with one embodiment of the present technology, with respect to requestor.

FIG. 5 is a flowchart of steps in an exemplary method for obtaining missing elements or components for a workflow segment.

FIG. 6 is a flowchart of steps in an exemplary method for sharing and managing workflows, with respect to processing requests.

FIG. 7 shows a flowchart of steps in an exemplary method for sharing and managing workflows, with respect to managing and processing requests, such as at a network directory for a transaction network; and

FIG. 8 illustrates an exemplary system that can be used to carry out any of the various embodiments or the components of any portion of a system carrying the various embodiments.

### DETAILED DESCRIPTION

The present technology is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the present technology can be implemented without one or more of the specific details or with other methods. In other instances, well-known structures or operations are not shown in detail to avoid obscuring features of the present technology. Additionally, the present technology is not limited by the illustrated ordering of acts or events, as some acts may occur in different orders and/or concurrently with other acts or events. Furthermore, not all illustrated acts or events are required to implement a methodology in accordance with the present technology.

In view of the limitations of conventional methods, the present technology provides a new multi-tenant system that supplies highly customizable transaction management capabilities for multiple collaborating entities without requiring the entities to settle for a solution with limited capabilities. The present technology allows such customization in a many-to-many network, whereby a single entity can share information and manage transactions with any number of other entities with losing their ability to customize the workflow for their specific needs.

In particular, the present technology enables the above-mentioned level of customization and collaboration by allowing entities to independently develop workflows and thereafter provide a sharing of such workflows, or portions thereof, with other entities. In some embodiments, this is implemented in a manner similar to associating with another a user on social network. That is, entities utilizing the present technology can request to be connected to other entities for purposes of sharing a workflow segment. The connection can require approval from one or both parties. In some embodiments, the connection request from one party must be expressly approved by the other party. Once entities are connected, they can share information, workflows, and portions thereof. Thus, the entities can collaboratively manage transactions and monitor business processes that are shared between their organizations.

Further, the present technology is scalable. That is, as the number of entities expands, this only provides additional opportunities for existing users to create and share a larger number of workflows or portions thereof. Thus, the present technology allows entities to easily connect with new business partners and further facilitate transaction management, visibility, and collaboration.

The present technology is usable for managing multiple types of transactions between multiple types of entities. Entities, as used herein, can include individuals or organizations and their network of trading partners, including vendors, customers, transportation providers and third party providers of services associated with supply chain operations. Each of these entity types can participate in their appropriate role in a transaction workflow. Further, the present technology allows participation by utilizing a website or other application or by system-to-system integration, including mobile device applications.

As noted above, multi-tenant applications that offer transaction management capabilities have been historically challenged by limitations on workflow configurability. For example, a multi-tenant web application offering shipment management capabilities between shippers and carriers typically cannot provide unique shipment workflows to all its customers. Rather, existing multi-tenant applications generally allow for deployment of a base workflow with limited customization for each customer. As noted above, even though such multi-tenant applications provide configuration capabilities to its customers, these settings do not customize the core functionality of the application. As a result, most multi-tenant web application offerings that provide transaction management features fail to provide a configurability option to meet individual or unique needs of an entity. Rather, as noted above, the workflow is typically a one-size-fits-all core feature of the offering.

Unfortunately, the problem is that for many entities, a one-size-fits-all transaction workflow may not meet the specific or unique needs of their business process. However, in order to utilize a web-based multi-tenant application to manage transactions, these entities generally have no option but to adopt the static workflow supported by these offerings.

In view of the foregoing, the problem with conventional multi-tenant workflows can summarized as follows:
a. Multi-tenant software architecture is required for web-based transaction management collaboration involving multiple entities, whereby one entity may share relationships with multiple other entities (e.g. a carrier may have relationships with multiple shippers, and a shipper may have relationships with multiple carriers).
b. Multi-tenant software architecture presents challenges to supporting unique transaction workflows between entities. The transaction workflows are not configurable features of these offerings.
c. As a result, customers of these offerings have historically adjusted their business process to fit the set workflows supported by these applications. Customers would prefer the ability to configure the workflows to match their business processes.

The present technology provides a solution to this problem. In particular, the present technology provides a solution in the form of a multi-entity transaction network, allowing trading partners to manage transactions in a web-based application (or other network-connected application), including mobile device applications. To enable this multi-tenant, customizable workflow environment, a new multi-tenant architecture is provided by the present technology. This new architecture is described below with respect to FIG. 1.

FIG. 1 is a schematic of a multi-tenant workflow environment 100 for a transaction network 101 in accordance with the one exemplary embodiment of the present technology. For ease of illustration, the environment 100 will be described with respect to two interaction entities, Entity A (a shipper) and Entity B (a carrier), but the various embodiments are not limited in this regard. Rather, an environment in accordance with the present technology can support any number of entities.

As shown in FIG. 1, each of the entities has a separate and independently operating virtualized application instance 102A, 102B. Further, each instance of the application 102A, 102B has its own associated virtualized instance database 104A, 104B. In some embodiments, an application instance and its associated database can be virtualized or logically separated (database schemas) to share infrastructure or operate on dedicated infrastructure.

Each of the application instances 102A, 102B is associated with a network directory 106 of the transaction network 101. That is, each application instance associated with an entity and participating in the transaction network 101 is included in the network directory 106. The network directory 106 provides each application instance 102A, 102B a means for identifying workflow information and connecting to other appropriate application instances for data synchronization. For example, if Entity A wants to enable order collaboration with its trading partner Entity B, the network directory 106 supports systems and methods for these entities to identify each other and authenticate a connection to share information. Specifically, the network directory can allow entities to register with a transaction network and generate an entity profile specifying information regarding an entity, including which portions of their respective workflows will be available to other entities. Thereafter, another entity, such a trading partner, can request connection with the registered entity utilizing an application web interface associated with the network directory 106. In some embodiments, the connection can be automatically approved, if specified by the profile of the registered entity. In other embodiments, an explicit approval can be required. That is, an entity is required to approve any requests from other entities via an interface to the network directory 106. In some embodiments, a combination of authentication methods can be used. For example, some requesting entities may be pre-approved for connection while other entities require explicit approval. In the various embodiments, requests, approvals, and pre-approvals can be provided by accessing another entity's profile. Further, other schemes for approving access and not described above can be used in the present technology.

In the various embodiments, the application instances 102A, 102B can be deployed by network directory 106 or some other central store when an entity joins the transaction network 101. For example, upon Entity A joining transaction network 101, the network directory 106 can be configured to allow deployment and installation of application instance 102A and creation of database 104A. In some embodiments, the application instances 102A, 102B can be deployed as a complete unit. That is, the application instances 102A, 102B, can include all elements, templates, or other objects required for generating workflows. In such configurations, the application instances 102A, 102B can be updated over time as additional objects are created.

Alternatively, the application instance 102A, 102B can be deployed as an incomplete unit. That is, the application instance 102A, 102B, can include all elements, templates, or other objects required for generating workflows for a limited set of transactions. In such configurations, as additional objects are needed, the application instances 102A, 102B, can communicate with the network directory 106 or some other central store to retrieve any additional object needed. Further, in some cases, the additional objects can be obtained for free or a payment can be required for such additional objects. Further, such objects can be only those generated by an entity managing the transaction network, objects generated by third parties, or both.

In addition to the network directory 106, the environment 100 can further provide a network data sync system 108. As noted above, each of entities 102A, 102B on the transaction network 101 maintains its own database 104A, 104B, respectively. Certain data is transferred and synchronized between entities via a data sync function of the transaction network 101. In accordance with the approvals required, data synchronization is only possible between entities that have approved connection by their application administrators. In some embodiments, the network data sync system 108 can be implemented as a server or other system operating independently of the network directory 106. In other embodiments, the network data sync system 108 can be implemented as part of the network directory 106.

Although the network data sync system 108 is illustrated in FIG. 1 as a separate entity, the various embodiments are not limited in this regard. For example, the network data sync system can be an object or component in each of the application instances in the network. In another example, some application instance may have such an object and other application instance may rely on a separate network data sync system.

Although the architecture in FIG. 1 has been described with respect to certain elements and features, this is solely for illustrative purposes. In the various embodiments, the present technology can be implemented using more or less elements than shown in FIG. 1.

Now that some basic elements of environment 100 have been described, the description will turn to a description of how such components can operate to support creation and sharing of customizable transaction workflows or portions thereof.

First, as noted above, present technology allows each entity on the network to configure their workflow so that a transaction business process can be customized beyond the template workflow model. This is enabled via the use of separate and independent application instances 102A, 102B for different entities, each which support a library of objects in the application instances 102A, 102B. These objects are described below.

Workflow and Workflow Templates

Basic transaction types supported by the transaction network 101 can have a default workflow template. The workflow template is the default business process for a given transaction type. For example, orders and shipments are transactions generally used by many types of entities. Thus, a default workflow template that represents a very simple and standard business process can be provided to allow entities to get up and running very quickly.

States, Actions and Applications

In general, a workflow is comprised of objects consisting of states, actions, and applications. A state is a transaction milestone or event, such as new, approved, shipped, paid or closed. An action is an entity-invoked or a system-invoked activity that progresses a transaction from one state to the next. Finally, an application is a bundle of business logic typically utilized to automate or optimize logic included in the workflow. For example, for a Shipment transaction, an example of a state would be “Confirmed by Carrier”; and example of an action would be “Tender Shipment”; and an example of an Application would be “Shipment Tendering.” And the user experience would represent this workflow with:
a. A button to press titled “Tender Shipment” that progresses a shipment from its current State forward in the workflow.
b. A bundle of logic packaged as an Application that applies rules to which carrier should be utilized for the shipment based on service, price, and capacity parameters.
c. A table of shipment transactions currently in the Confirmed by Carrier state.
   Via the adjustment of objects in the workflows and workflow templates, the present technology allows entities to adjust default templates by adding, removing, or altering objects therein to create new workflows or workflow templates. Alternatively, the present technology also allows entities to create completely new workflows or workflow templates.

Workflow Editor

In some embodiments, entities can configure workflow and workflow templates by utilizing a workflow editor, web-based or otherwise. Thus, an entity can extend the template workflow model by adding states, actions and applications. Further, the workflow editor allows users to apply settings and parameters to each state, action, and application. Once the updated configurations are submitted in the editor, the workflow can be updated to include these new workflow components. Operation of the workflow editor is described in further detail with respect to FIG. 2.

FIG. 2 is a schematic illustration 102 of the operation of a workflow editor with respect to an application instance, in accordance with an embodiment of the present technology. As illustrated in FIG. 2 above, the user can access the workflow editor in a web browser-based user interface 202. However, the various embodiments are not limited in this regard and any other interface type suitable for carrying out the editing described below can be used in the present technology. Referring back to FIG. 2, the user is presented with a default workflow 204 for a transaction type, entitled “New”, consisting of a set of default template states and actions (204A and 204B). The user may configure this template workflow 204 by selecting a point in the workflow and selecting an add option 206, upon which they are presented with the option to either add a new State/Action pair 206B or to add an Application 206B. If the user chooses to add a State/Action pair then the user can also specify input parameters for this new action and new state. If the user selects to add an application, the user can choose the application from a directory of available applications for this transaction type. The directory can show the applications available at the application instance, including any applications created by the entity. However, in some embodiments, a directory of application available via the network directory or some other central store can also be presented at interface 202.

Once the configuration of the workflow is completed, the updated Configured Workflow 208 can be presented to the user in the user interface 202. For example, as shown in FIG. 2, the Configured Workflow 208 shows not only the components 204A and 204B originally in default workflow 204, but also any added components, such as new action 208A and new state 208B. In some embodiments, the Configured Workflow 208 can be presented in a preview fashion. That is, as the user is configuring the workflow, the resulting workflow is presented at the user interface 202 so that the user can visualize the changes before he commits to a change. Once the changes to the workflow are made, the new configuration for the workflow is saved in the database 210 of the application instance 212 and these new workflow parameters are utilized to process transactions from that point forward.

When adding new States and Actions to a workflow, the following parameters can be set or specified:
a. New State Name: custom name for new transaction state;
b. New Action Name: custom name for the action that moves transaction from prior state to new state;
c. Role Access: user roles that are granted ability to invoke this action on their user interface;
d. Required Fields: data fields that are required input for this action (For example, an action can present a form in the user interface and require a user to input data for the transaction); and
e. Start new Thread: the ability to branch the process into a new workflow thread.
   For example, for a shipment transaction, a user can add a new State=“Payment Complete” and the action can be “Pay Carrier.” For configuring this custom workflow step, the user can configure that a user must input data into a required field titled “Invoiced Amount” and that only “Administrator” role types can invoke this action. The result of this additional workflow step would produce a table of shipments visible in the user interface that are ready for payment and have columns in the table for display of invoiced amount input by users. This table can also be configured to display data from the system such as the cost of the shipment as determined by the Rating Application and a column displaying any variance between Invoiced Amount and the system generated cost. Thus, the workflow editor's capabilities can be utilized in many different ways. The set of parameters (a)-(e) is provided for illustrative purposes only and a different set of parameters can be utilized in other embodiments.

Although FIG. 2 is generally described with respect to the adding of actions, states, and applications, the present technology is not limited in this regard. That is, the present technology also contemplates that actions, states, and application of an existing workflow can be adjusted, removed, or replaced. The operations to remove or replace such workflow components can be carried out in substantially a same fashion as described above with respect to adding applications and states. That is, the component to be adjusted, removed, or replaced can be selected. Thereafter, the user can select carry out the necessary operation on the selected component. Further, the creation of workflows or the editing or creation of workflow templates can be carried out in a substantially similar manner as described above with respect to FIG. 2. In the creation of a workflow or workflow template, the only difference would be that initially, no default workflow would be presented.

As noted above, the present technology permits the sharing of workflows, or portions thereof. This sharing process will be described below in greater detail with respect to FIGS. 3, 4, 5, and 6. However, prior to such discussions, it should be noted that the in certain circumstances the present technology can be configured to limit the visibility or access of a requesting entity to certain workflow components or objects. In some embodiments, this can be accomplished by managing visibility and access to states. Thus, various types of states can be generated for a workflow by an entity.

A first type of state can be a fixed network state. Fixed network states in transaction workflows can be configured to be visible to other entities, but are configured such that they generally cannot be edited by users in the workflow editor once the state is shared among multiple entities. That is, within the web browser-based workflow editor, Fixed Network States are not editable by the user. The user may not delete them and their position in the workflow relative to other Network States may not be changed. The reason for such limitations is that such fixed network states will generally serve as the integration points for transaction activities that include more than one entity. As such, entities require that the configuration of such states be fixed to avoid issues during operation. That is, if a state configuration is altered without any notice, the workflow of other entities can be adversely affected. Typically, such states can be used to provide the default or initially shared states between entities associated with a transaction. Therefore, they can be used to define the core elements required to allow sharing of information between entities.

For example, referring to FIG. 1, a Shipper (Entity A) and a Carrier (Entity B) share common default network states 110A, 110B (each including State 3 and State 4) that provide the ability for both parties to participate in a shared business process. The values for these network states could be “In-Transit” and “Delivered”, where information needs to be shared and visible to both parties. As the shipment transaction flows through these states, it is necessary that it remain visible and actionable to the entities that share this transaction. Further, data inputs provided while the transaction is in these states needs to be synchronized between the entities, so that the database of each entity maintains the proper attributes of each transaction. However, if a change is unilaterally made at one entity or another for one or both states, the ability of these states to be visible, actionable, or synchronized may disappear for the other entity. Thus, by making such states fixed, these issues can be avoided. Accordingly, in some embodiments, the default network states can be “hard coded” into the application instances associated with a transaction to prevent any alterations thereof.

Although fixed network states are described above to not be subject to any alterations, the present technology contemplates that in some circumstances, changes can be allowed. For example, in some configurations, a new version of a state can coexist with the old version. Thus, other entities can receive notification of the new version and take the necessary steps to incorporate the new version, while still having access to the old version. In another example, an “outage” can be scheduled by one entity for updating the fixed state and during the “outage” the various entities can coordinate to incorporate the changes. Any other methods for coordinating an updating of a state can also be utilized in the present technology.

As noted above, there may be some states that an entity does not wish to share or for which the associated data should not be visible to other entities. Thus, these states can be established as private or local configured states. Local configured states are not shared with other entities and the data inputs do not need to be synchronized between entities. For example, a company can configure the workflow to extend an order transaction business process to include different departments of their own company. Since this process does not require that such states be shared outside their company, these local states operate from their own server locally and do not need to sync across the network. Further, such states would not be added to the network directory. For example, referring to FIG. 1, a Shipper (Entity A) may have private of local configured states 114A (including State 2, State 5, and State 6) that include portions of the Shipper's workflow that are not to be shared.

Finally, there may be states that an entity may use for a workflow, but that are not required for operation of the core functions of the workflow or that are used to enhance the core functions of the workflow. For example, state 115A can be added at Entity A as a new state to be shared for a transaction with entity B associated with the workflow segment 110A. This state can then be added to workflow 112B of Entity A as state 115B. Thus, these states can be established as configured network states, which can be shared among entities. In some embodiments, the configured network states can operate similar to the default network states. That is, they can be established, shared with other entities, and synchronized, as described above. In some cases, they can be fixed at time of creation, similar to default network states. Thus, they can become part of the default network states. In other embodiments, they can be adjusted over time, or even deleted, as required by the needs of the transaction workflow.

In other embodiments, configured network states can be shared with other entities, but for which the data inputs do need to be synchronized between entities. For example, a company can configure a customized workflow and share it with other specific companies on the network. These shared states do not by default integrate into a template workflow of another company. If Company A wanted to create a new state to share transactions with Company B, they could set up a configured network state 115A, specify to share it with Company B, and this state would appear as a stand-alone, unconnected state 115B for Company B. Company B could then choose to connect this new shared state into their own workflow 112B.

Data Synchronization

As noted above, the present technology allows each entity in a transaction network to process transactions through the configured workflow. Further, as also described above, a transaction workflow may involve collaboration with another entity. The present technology contemplates several types of data synchronization rules to enable transaction collaboration between entities.
a. Entity or Local data attributes. As noted above, some types of data do not need to be shared with other network entities. Rather, such data is only stored locally in the entity database. Thus, no synchronization is required. For example, entity/company-sensitive data such as logistics service provider rates are stored locally and should not be shared with other entities.
b. Network data object. Attributes that need to be shared between entities are network data objects. A master copy of a network object is stored in the database of the object owner. For example, if Entity A creates a shipment transaction, it is the owner of this transaction and a master copy of this transaction is stored in the database of Entity A. Attributes of this network object are shared via synchronization when another entity interacts with this object via a network state. If Entity B is a carrier and provides tracking data about a shipment created by Entity A. Entity B is authorized to provide this data as a result of its participation in the network states of the shipment workflow. Data input by both entities is synchronized between them.

Now that some basic principles of the present technology have been discussed, the discussion will now turn to the operation of the various embodiments, with reference to FIGS. 1 and 2, as needed.

In some embodiments, entities may operate in a hub and spoke or a hierarchical configuration. That is a transaction originating entity may be in a relationship with one or more trading partner entities to provide the “hub” and “spoke” entities or “parent” and “child” entities, respectively. In the case of a workflow, this results in the hub entity sharing a portion of its workflow with the spoke entities to allow the entities to share in visibility and management of a transaction through the shared states of the workflow. For example, a shipper (e.g., Entity A in FIG. 1) can be a hub and its carriers (e.g., Entity B in FIG. 1) can be spokes, because the shipper entity originates shipment transactions that it then transmits or otherwise shares with its carriers. Similarly, a retailer can be a hub and its vendors are spokes, because the retailer originates order transactions that it then transmits or shares with its vendors. Any other similar relationship is also contemplated in the various embodiments to provide a hub and spoke configuration.

Now turning to FIG. 3, there is shown a flowchart of steps in an exemplary method 300 for managing and sharing workflows in accordance with one embodiment of the invention. The method can begin at step 302 and continue to step 304. At step 304, a hub entity can establish a local workflow and configure the local database using the local application instance. For example, Entity A in FIG. 2 can establish a workflow 112A directed to its business process for selling and delivering products to its customers. To that end, a user associated with Entity A can establish, according to the process of FIG. 2 or a similar process, workflow 112A, as shown in FIG. 1, with all of the states required by Entity A for carrying out its shipping process, i.e., State 2, State 5, and State 6 (collectively configured states 114 in workflow 112A).

Once the workflow is established at step 304, the hub entity can share at least a part of its workflow (i.e., one or more workflow segments) with one or more spoke entities at step 306. For example, as illustrated in FIG. 1, Entity A (a shipper) can share the network states 110A from workflow 112A with Entity B (a carrier), which Entity B can then incorporate as incorporate as workflow segments 110B into its workflow 112B. Thus, Entities A and B share in visibility and management of a transaction originated at Entity A through these states. As a result of step 306, each of the hub and spoke entities has, respectively, an initial or default workflow. Further, these workflows are linked, as described above.

In the various embodiments, workflow segments can be shared in a variety of ways. In some embodiments, the shared workflow segments can be provided a priori. Thus, the hub and spoke entities are pre-configured for certain transactions or types thereof. In other embodiments, the shared workflow segments can be provided as part of a transaction. That is, when the hub entity requires the spoke entity to perform a transaction, the configuration data for a shared workflow segment can be provided to the spoke entity and the spoke entity can configure itself for the hub entity's shared workflow segment. Thus, spoke entities can be associated with a hub entity dynamically. In some cases, the workflow segment may only be shared temporarily (e.g., for a specific transaction) and is deleted upon completion of a transaction. In other embodiments, the shared workflow segment may be persistent and remain available at the spoke entity even after the completion of a related transaction.

Further, the sharing of workflow segments and subsequent synchronization between the may include some type of authentication process. That is, a spoke entity may need to provide authentication information to a hub entity before it shares the workflow segments or allows the synchronization of data between entities.

After the workflow segments are shared, as described above, the local database can then be updated at step 308. In particular, the local database can synchronize entries for the workflow segment with those of a remote database. For example, when workflow 112A is in operation, the entries for State 3 and State 4 in database 104A can be synchronized with the corresponding entries in database 104B via network data sync system 108, based on actions at the various entities. In the various embodiments, the synchronization schedule can vary. In some embodiments, synchronization can occur whenever a change is made at the remote database. That is, if a change a database 104B occurs, a synchronization process with database 104A is initiated, and vice versa. In other embodiments, synchronization can occur whenever the local workflow is going to use the workflow segment. For example, before transitioning workflow 112A from State 2 to State 3, a synchronization of database 104A with database 104B occurs to ensure the workflow segment is performed with the latest information for the shared workflow segment. The synchronization can then be repeated as along as the workflow is in operation.

In some circumstances, changes in the workflow at the hub entity may be required. For example, referring back to FIG. 1, an adjustment, addition, or deletion of one or more states for 112A at Entity A may be required. Accordingly, following step 308, the method 300 can monitor the hub entity for changes in the current workflow at step 310. In the event that a change in the workflow initialized at the hub entity is detected at step 310, a determination can be made at step 312 as to whether or not the changes need to be propagated to the one or more spoke entities associated with the hub entity. For example, if the change is made in one of the local configured states 114A of workflow 112A at Entity A, then no changes are propagated. Thus, if none of the changes need to be propagated, the method 300 can repeat step 308 and 310. In contrast, if there is a change in workflow at Entity A, such as via the addition or medication of state 115A (or, if allowed, the modification of workflow segment 110A), then changes at Entity A may be propagated. Accordingly, method 300 can proceed to step 314.

At step 314, the changes in the workflow segment are propagated to the spoke entities. That is, a hub entity (e.g., Entity A) can cause that configuration data for the modified workflow segment to be forwarded to the one or more spoke entities (e.g., Entity B) associated with the hub entity. This configuration data can be received directly from the hub entity, from the network directory, or some other entity in the network. Thereafter, at step 316, the configuration data is used to add the workflow segment to the workflow of the spoke entity. For example, Entity B can utilize the configuration data to modify workflow 112B. The method can then return to steps 308-312 to synchronize as needed and to determining if any other changes in the shared workflow segments have been made.

In the various embodiments, the configuration data is designed to instruct an application instance how to construct a working workflow segment. It can describe, at a minimum, the components or elements needed for the workflow segment and the alternations needed in the database associated with the application instance to support such elements. Thus, when the configuration data is received by Entity B, the configuration data is utilized to select and arrange the components from application instance 102B needed for the modifying workflow 112B and also to update the instance database 104B to support the modifications to workflow 112B. As noted above, if one or more components are missing from an application instance, the components can be retrieved from network directory 106 or some other central store. This is described in greater detail below with respect to FIG. 5.

Although method 300 is described primarily with respect to a simple relationship consisting of a single hub entity and one or more spoke entities, the various embodiments are not limited in this regard. Rather, the relationships between entities can be complex. For, example, a spoke entity may be configured to receive workflow segments provided by multiple hub entities. For example, a carrier may serve a variety of shippers. Further, some spoke entities can also serve as hub entities for other entities (“sub-spokes”). Thus, a hierarchy of entities may be provided. For example, a carrier may have subcontractors or other entities that assist it in performing transactions, including the transaction with the original hub entity. In the case of the latter, the sub-spoke may have access to all or a port of the shared workflow segment from the original hub entity. However, in some configuration, the shared workflow segment can be private with respect to sub-spokes.

Further, the sharing of workflow segments between hub entities and spoke entities can also be complex. For example, the sharing of workflow segments can be entity-specific or even transaction-specific. In the case of entity-specific sharing, the hub entity may have rules for propagating changes in workflow segments to spoke entities based on the identity or type of the spoke entity. Thus, the hub entity can selectively propagate changes to different spoke entities (or types thereof) such that shared workflow segments are altered only at specific entities (or types thereof). In the case of transaction-specific sharing, the hub entity may have rules for propagating changes in workflow segments to spoke entities based on a per transaction basis or based on the type of transaction. Thus, the hub entity can propagate the changes in the shared workflow segments at a spoke entity that is associated with certain types of transactions or propagate the changes in the shared workflow segment on a per-transaction basis.

In some embodiments, the entities may operate in a peer-to-peer configuration. That is, entities can share workflow segments with entities other than those involved in specific transactions. This is illustrated with respect to FIG. 4 is a flowchart of steps in an exemplary method 400 for managing and sharing workflows in accordance with one embodiment of the present technology, with respect to requestor. The method 400 can begin at step 402 and continue on to step 404. At step 404, an entity can establish a local workflow and configure the local database using a local application instance. For example, Entity A in FIG. 2 may establish a workflow 112A directed to its business process for selling and delivering products to its customers. To that end, a user associated with Entity A can establish, according to the process of FIG. 2 or a similar process, workflow 112A with all of the states required by Entity A for carrying out its shipping process, i.e., State 2, State 5, and State 6 (collectively configured states 114 in workflow 112A).

While establishing the workflow, the user may recognize that he requires a portion of the shipment workflow 112B from his carrier (Entity B). For example, as shown in FIG. 1, State 3 and State 4 (110B) from workflow 112B can be required by Entity A in workflow 112A to form a complete workflow. Thus at step 406, a workflow or portion thereof (hereinafter “workflow segment”) from the carrier can be identified. As noted above, the workflow segment can be made available via network directory 106 or some other central server. For example, the user associated with Entity A can access the profile associated with Entity B and identify any workflow segments of interest. In another example, the network directory 106 can generate a listing of all available workflow segments from all entities and allow the user to identify the workflow segment of interest. Any other methods for identifying workflow segments via a user interface can also be used in the present technology.

Once the workflow segment is identified at step 406, the method can proceed to step 408. At step 408, a request is forwarded to obtain access to the workflow segment. As noted above, access to workflow segments is controlled; therefore the request can include authentication information. In the various embodiments, the request can be provided in various ways. In some configurations, the request can be a message from one Entity A to the network director 106 to obtain access to the workflow segment from Entity B. Alternatively, the request can be in the form of a request posted by Entity A on the profile page of Entity B. However, the various embodiments are not limited to any particular method of supplying a request and other methods can be used with the present technology.

As noted above, the request can be accompanied by authentication information. In some embodiments, this information can be username/password type information. In other embodiments, the authentication information can be biographical or other information regarding the requestor. Thereafter, this information can be analyzed to determine if it belongs to a party authorized to access the workflow segment. In additional, encoding, encryption, and any other methods of secure communications can be used with the present technology to ensure that the authentication information and, optionally, other portions of the request are kept private.

Responsive to the request, Entity A can receive, at step 410, configuration data for the workflow segment. This configuration data can be received directly from the other entity or from the network directory. Thereafter, at step 412, the configuration data is used to add the workflow segment to the workflow. For example, Entity A can utilize the configuration data to add State 3 and State 4 to workflow 112A.

In the various embodiments, the configuration data is designed to instruct an application instance how to construct a working workflow segment. It can describe, at a minimum, the components or elements needed for the workflow segment and the alternations needed in the database associated with the application instance to support such elements. Thus, when the configuration data is received by Entity A, the configuration data is utilized to select and arrange the components from application instance 102A needed for State 3 and State 4 in workflow 112A and also to update the instance database 104A to support State 3 and State 4. As noted above, if one or more components are missing from an application instance, the components can be retrieved from network directory 106 or some other central store. This is described with respect to FIG. 5.

Referring back to FIG. 4, after the workflow segment is added to the local workflow in step 412, the local database can then be updated at step 414. In particular, the local database can synchronize entries for the workflow segment with those of a remote database. For example, when workflow 112A is in operation, the entries for State 3 and State 4 in database 104A can be synchronized with the corresponding entries in database 104B via network data sync system 108. In the various embodiments, the synchronization schedule can vary. In some embodiments, synchronization can occur whenever a change is made at the remote database. That is, if a change a database 104B occurs, a synchronization process with database 104A is initiated. In other embodiments, synchronization can occur whenever the local workflow is going to use the workflow segment. For example, before transitioning workflow 112A from State 2 to State 3, a synchronization of database 104A with database 104B occurs to ensure the workflow segment is performed with the latest information for the shared workflow segment. The synchronization can then be repeated as along as the workflow is in operation.

FIG. 5 is a flowchart of steps in an exemplary method 500 for obtaining missing elements or components for a workflow segment. The method 500 begins at step 502 and continues to step 504. At step 502, the elements or components missing from a local application instance, but required for a workflow segment, are identified. If such elements are missing or absent, then these can be retrieved and added to the local application instance, at step 506, from a central server or store, such as network directory 106. Finally, the once such missing elements and components are retrieved; the workflow segment can be added at step 508. The method can then resume previous processing at step 510, including performing any of the methods described herein.

Now turning to FIG. 6, there is shown a flowchart of steps in an exemplary method 600 for sharing and managing workflows, with respect to processing requests. The method 600 can being at step 602 and proceed to step 604. At step 604, a local workflow and an associated local database can be established for a local application instance. For example, Entity B can establish a workflow 112B including State 3 and State 4. Additionally, Entity B can configure the local database 104B to support State 3 and State 4. This can be done in a same or similar manner as that described with respect to FIG. 2.

Thereafter, at step 606, the local application instance can publish the availability of any workflow segments from the workflow. For example, the application instance 102B for Entity B can publish the availability of workflow segment 110B. This publication can be done via network directory 106. For example, the workflow segments can be published in a listing maintained at network directory, a profile page associated with the local application instance, or some other location.

In response to the publication at step 606, an authenticated request can be received at step 608. The request, authenticated by the network directory or some other central server, can request access to a specific workflow segment. Thereafter, at step 610, the configuration data for the workflow segment can be assembled and forwarded to the requesting application instance. As noted above, the configuration data specifies how to generate the workflow segment at another application instance and the required database entries needed to support the workflow segment.

In some embodiments, rather than generating the configuration data at the time of request, the configuration data can be pre-generated and stored at either the local application instance or the network directory. In that configuration, upon receipt of the authenticated request, the configuration data can be immediately forwarded.

Once the configuration data is forwarded at step 610, the local database can be synchronized with the remote database associated with the request. The synchronization can be performed as described above with respect to FIG. 4.

As noted above, in some cases the configuration of all or a part of the workflow segment can be locked to ensure the workflow segment is consistently operating for all entities. For example, at step 614, following the receipt of the request for a workflow segment, the workflow segment can be locked. Therefore, if at some point as request to alter a workflow segment is received, such as at step 616, the method 600 can determine at step 618 whether locking has occurred. If locking has occurred, no changes are made and the method 600 continues. If no locking has occurred, the changes are made at the local application instance at step 620. Further, updated configuration data can be forwarded to the remote application instance so that the same changes are effected. The method 600 can then resume previous processing.

Now turning to FIG. 7, there is shown a flowchart of steps in an exemplary method 700 for sharing and managing workflows, with respect to managing and processing requests, such as at a network directory for a transaction network. The method can begin at step 702 and continues to step 704. At step 704, workflow segments available from application instances are published. As discussed above, this can entail the publishing of a list of available workflow segments, the publishing of profile pages for different entities, or any other type of publication allowing a user to select a workflow segment.

At step 706, a request can be received from a first application instance to access a workflow segment associated with a second application instance. As noted above, the request can not only identify the requested workflow segment, but can also specify authentication information for the requestor. Thereafter, at step 708, the authentication information from the request can be compared to the authentication information stored for the workflow to see if the requesting entity is entitled to utilize the workflow segment. As previously discussed, the authentication information can be a username/password pair or any other type of identifying information.

If there is no match at step 710, access is denied and the method 700 can resume previous processing at step 716. In contrast, if there is a match at step 710 the method can proceed to step 712. At step 712, configuration data for the workflow segment is obtained. As previously noted, this configuration data can be obtained from the first application instance. Alternatively, the configuration data can be stored at the network directory and retrieved upon confirmation of the authentication data. Thereafter, at step 714, the configuration data can be forwarded to the second application instance, as previously described. The method 700 can then resume previous processing at step 716, including repeating any of the methods described herein.

FIG. 8 illustrates an exemplary system 800 that can be used to carry out any of the various embodiments of the present technology or the components of any portion of a system carrying the various embodiments of the present technology. However, any portion of such a system can include more or less components than shown in FIG. 8. FIG. 8 defines a general-purpose computing device 800, including a processing unit (CPU or processor) 820 and a system bus 810 that couples various system components including the system memory 830, such as read only memory (ROM) 840, and random access memory (RAM) 850 to the processor 820. The system 800 can include a cache 822 of high speed memory connected directly with, in close proximity to, or integrated as part of the processor 820. The system 800 copies data from the memory 830 and/or the storage device 860 to the cache 822 for quick access by the processor 820. In this way, the cache 822 provides a performance boost that avoids processor 820 delays while waiting for data. These and other modules can control or be configured to control the processor 820 to perform various actions. Other system memory 830 may be available for use as well. The memory 830 can include multiple different types of memory with different performance characteristics. It can be appreciated that the disclosure may operate on a computing device 800 with more than one processor 820 or on a group or cluster of computing devices networked together to provide greater processing capability. The processor 820 can include any general purpose processor and a hardware module or software module, such as module 1 862, module 2 864, and module 3 866 stored in storage device 860, configured to control the processor 820 as well as a special-purpose processor where software instructions are incorporated into the actual processor design. The processor 820 may essentially be a completely self-contained computing system, containing multiple cores or processors, a bus, memory controller, cache, etc. A multi-core processor may be symmetric or asymmetric.

The system bus 810 may be any of several types of bus structures including a memory bus or memory controller, a peripheral bus, and a local bus using any of a variety of bus architectures. A basic input/output (BIOS) stored in ROM 840 or the like, may provide the basic routine that helps to transfer information between elements within the computing device 800, such as during start-up. The computing device 800 further includes storage devices 860 such as a hard disk drive, a magnetic disk drive, an optical disk drive, tape drive or the like. The storage device 860 can include software modules MOD1 862, MOD2 864, MOD3 866 for controlling the processor 820. Other hardware or software modules are contemplated. The storage device 860 is connected to the system bus 810 by a drive interface. The drives and the associated computer-readable storage media provide nonvolatile storage of computer readable instructions, data structures, program modules and other data for the computing device 800. In one aspect, a hardware module that performs a particular function includes the software component stored in a non-transitory computer-readable medium in connection with the necessary hardware components, such as the processor 820, bus 810, output device 870, and so forth, to carry out the function. The basic components are known to those of skill in the art and appropriate variations are contemplated depending on the type of device, such as whether the device 800 is a small, handheld computing device, a desktop computer, or a computer server.

Although the exemplary embodiment described herein employs a hard disk as storage device 860, it should be appreciated by those skilled in the art that other types of computer-readable media which can store data that are accessible by a computer, such as magnetic cassettes, flash memory cards, digital versatile disks, cartridges, random access memories (RAMs) 850, read only memory (ROM) 840, a cable or wireless signal containing a bit stream and the like, may also be used in the exemplary operating environment. Non-transitory computer-readable storage media expressly exclude media such as energy, carrier signals, electromagnetic waves, and signals per se. However, non-transitory computer-readable storage media do include computer-readable storage media that store data only for short periods of time and/or only in the presence of power (e.g., register memory, processor cache, and Random Access Memory (RAM) devices).

To enable user interaction with the computing device 800, an input device 890 represents any number of input mechanisms, such as a microphone for speech, a touch-sensitive screen for gesture or graphical input, keyboard, mouse, motion input, speech and so forth. An output device 870 can also be one or more of a number of output mechanisms known to those of skill in the art. In some instances, multimodal systems enable a user to provide multiple types of input to communicate with the computing device 800. The communications interface 880 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 820. The functions these blocks represent may be provided through the use of either shared or dedicated hardware, including, but not limited to, hardware capable of executing software and hardware, such as a processor 820, that is purpose-built to operate as an equivalent to software executing on a general purpose processor. For example, the functions of one or more processors presented in FIG. 8 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 840 for storing software performing the operations discussed below, and random access memory (RAM) 850 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 800 shown in FIG. 8 can practice all or part of the recited methods, can be a part of the recited systems, and/or can operate according to instructions in the recited non-transitory computer-readable storage media. Such logical operations can be implemented as modules configured to control the processor 820 to perform particular functions according to the programming of the module. For example, FIG. 8 illustrates three modules MOD1 862, MOD2 864 and MOD3 866, which are modules configured to control the processor 820. These modules may be stored on the storage device 860 and loaded into RAM 850 or memory 830 at runtime or may be stored as would be known in the art in other computer-readable memory locations.

While various embodiments of the present technology have been described above, it should be understood that they have been presented by way of example only, and not limitation. Numerous changes to the disclosed embodiments can be made in accordance with the disclosure herein without departing from the spirit or scope of the present disclosure. Thus, the breadth and scope of the present technology should not be limited by any of the above described embodiments. Rather, the scope of the present disclosure should be defined in accordance with the following claims and their equivalents.

Although the present technology has been illustrated and described with respect to one or more implementations, equivalent alterations and modifications will occur to others skilled in the art upon the reading and understanding of this specification and the annexed drawings. In addition, while a particular feature of the present technology may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which the present technology belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A method of sharing work segments among different application instances, comprising:
sharing at least one portion of a workflow at a first application instance associated with a first entity originating transactions with at least one second application instance associated with at least one second entity servicing the transactions;
detecting a change in the portion of the workflow at the first application instance; and
based on one or more criteria, selectively propagating at least a portion of the change to the at least one second application instance.

2. The method of claim 1, wherein the criteria comprises at least one of transaction criteria or entity criteria.

3. The method of claim 1, wherein the sharing comprises forwarding configuration data to the at least one second application instance, the configuration data comprising information for configuring the at least one second application instance to incorporate the at least one portion of the workflow into the second application instance.

4. The method of claim 1, wherein the sharing comprises selecting the at least one second application instance from a library of remote application instances.

5. The method of claim 3, wherein the configuration data further comprises authentication information for the at least one second application instance to access transaction data associated with the at least one portion of the workflow.

6. The method of claim 1, wherein the propagating comprises forwarding configuration data to the at least one second application instance, the configuration data comprising information for configuring the at least one second application instance to incorporate the portion of the change into the at least one portion of the workflow at the second application instance.

7. A method of sharing work segments among different application instances, comprising:
incorporating at least one portion of a workflow at a first application instance associated with a first entity originating transactions into a workflow of a second application instance servicing the transactions;
receiving, at the second application instance, a notification of a change in the portion of the workflow at the first application instance;
adjusting the workflow at the second application instance based on the change;
after the adjusting, synchronizing the workflow at the second application instance with the workflow at the first application instance.

8. The method of claim 7, wherein the incorporating comprises receiving configuration data at the second application instance, the configuration data comprising information for configuring the second application instance to incorporate the at least one portion of the workflow into the second application instance.

9. The method of claim 8, wherein the configuration data further comprises authentication information for the at least one second application instance to access transaction data associated with the at least one portion of the workflow.

10. The method of claim 1, wherein the notification comprises configuration data, the configuration data comprising information for configuring the at least one second application instance to incorporate the portion of the change into the at least one portion of the workflow at the second application instance.

11. A system comprising:
a first computing device comprising a first application instance associated with a first entity originating transactions;
a second computing device comprising a second application instance associated with at least one second entity servicing the transactions;
wherein the first application instance is configured for sharing at least one portion of a workflow at the first application instance with the second application instance, detecting a change in the portion of the workflow at the first application instance, and based on one or more criteria, selectively propagating at least a portion of the change to the at least one second application instance;
wherein the second application instance is configured for incorporating the at least one portion of the workflow at a first application instance into a workflow of the second application instance, receiving a notification of the change at the first application instance, adjusting the workflow at the second application instance based on the change, and synchronizing the workflow at the second application instance with the workflow at the first application instance after the adjusting.

12. The system of claim 11, wherein the criteria comprises at least one of transaction criteria or entity criteria.

13. The system of claim 11, wherein the sharing comprises forwarding configuration data to the at least one second application instance, the configuration data comprising information for configuring the at least one second application instance to incorporate the at least one portion of the workflow into the second application instance.

14. The system of claim 13, wherein the configuration data further comprises authentication information for the second application instance to access transaction data associated with the at least one portion of the workflow.

15. The system of claim 11, wherein the first application instance is configured to select the second application instance from a library of remote application instances

16. The system of claim 13, wherein the configuration data comprising information for configuring the at least one second application instance to incorporate the portion of the change into the at least one portion of the workflow at the second application instance.
